(19) United States
(12) Patent Application Publication
(10) Pub. No.: US 2024/0391790 A1
(43) Pub. Date: Nov. 28, 2024

(54) A PROCESS FOR PRODUCING ALUMINA

(71) Applicant: Tianqi Lithium Kwinana Pty Ltd, Western Australia (AU)

(72) Inventors: Yafeng Guo, Western Australia (AU); Hazel Lim, Western Australia (AU)

(73) Assignee: Tianqi Lithium Kwinana Pty Ltd, Western Australia (AU)

(21) Appl. No.: 18/694,028

(22) PCT Filed: Sep. 21, 2022
(86) PCT No.: PCT/AU2022/051143

§ 371 Date: Mar. 21, 2024

(30) Foreign Application Priority Data
Sep. 21, 2021 (AU) 2021903036

(51) Int. Cl. C01F 7/306; C01C 1/16; C01F 7/56

(52) U.S. Cl. CPC C01F 7/306; C01C 1/164; C01F 7/56; C01P 2006/80

(57) ABSTRACT

A process for extracting values from a leach residue from lithium extraction comprising:

(a) mixing the leach residue with a chloride containing compound to form a first mixture;

(b) calcining the first mixture to form a calcined mixture rich in calcium aluminosilicate and a hydrochloric acid containing off gas;

(c) acid leaching the calcined mixture to form an aluminium bearing liquor and a silicon rich solid residue;

(d) recovering values selected from the group consisting of aluminium compounds, silicon compounds and compounds containing silicon and aluminium.

### TECHNICAL FIELD

The invention relates to a process for producing alumina from a leach residue. In particular, the leach residue is that formed by leaching beta or β-spodumene for extraction of lithium.

### BACKGROUND ART

The following discussion of the background art is intended to facilitate an understanding of the present invention only. The discussion is not an acknowledgement or admission that any of the material referred to is or was part of the common general knowledge as at the priority date of the application.

A range of processes are available for producing lithium salts of high purity for use in electric batteries. Key lithium salts for use in electric batteries include lithium hydroxide monohydrate and lithium carbonate. One process route involves acid leaching of calcined spodumene (B-spodumene), which has a low iron content (say 80-1500 ppm Fe: Aylmore, M et al., Assessment of a spodumene ore by advanced analytical and mass spectrometry technique to determine its amenability to processing for the extraction of lithium, Minerals Engineering, April 2018, 137-148), to produce a lithium sulphate solution and a leach residue, or lithium slag, which is a low value by-product—with past utility as a construction material-if not subjected to further processing which must take into account its specific mineralogy.

The leach residue from lithium extraction could be processed to zeolites or high purity alumina though processes may be complex. One process for producing high purity alumina is described in the Applicant's International Publication No. WO2019148233 which involves hydrothermally treating lithium slag with an aqueous solution of an alkaline compound at selected temperature and duration. An ion exchange step is performed on the alkaline treated lithium slag. Then values selected from the group consisting of aluminium compounds, silicon compounds and compounds containing silicon and aluminium are recovered from the ion exchanged alkaline treated lithium slag. A value of particular interest is high purity alumina.

An important consideration in development of lithium refining processes is process sustainability. It is undesirable to produce large quantities of solid waste and, where possible, reagent regeneration and re-use in processes should also be practised. Further, and with specific reference to lithium slag, the material is resistant to leaching and this presents a challenge in further processing.

It is an object of the present invention to provide an improved process for extracting values, such as alumina and silica desirably of high purity, from lithium slag.

### SUMMARY OF INVENTION

The present invention provides, in one embodiment, a process for extracting values from a leach residue from lithium extraction comprising:
(a) mixing the leach residue with a chloride containing compound to form a first mixture;
(b) calcining the first mixture to form a calcined mixture rich in calcium aluminosilicate and a hydrochloric acid containing off gas;
(c) acid leaching the calcined mixture to form an aluminium bearing liquor and a silicon rich solid residue; and
(d) recovering values selected from the group consisting of aluminium compounds, silicon compounds and compounds containing silicon and aluminium.

The chloride containing compound is conveniently selected from the group consisting of calcium chloride, ferrous or ferric chloride. Calcium chloride is particularly preferred though other chlorides may also be suitable for the calcination step. The chloride compound is conveniently in crystalline rather than anhydrous form, for example with calcium chloride dihydrate being preferably used in the case of calcium chloride.

Calcining of the first mixture is preferably conducted at a temperature in the range 700 to 1600° C., with 800-1100° C. being more preferable. Calcining duration is preferably 0.5 to 6 hours, with 1 to 2.5 hours being more preferable. Ratio of leach residue to chloride compound (by weight) is in the range 1:2 to 1:0.33 with 1:0.5 to 1:1 being preferred.

The calcined mixture is conveniently milled prior to acid leaching step (c). Such milling reduces particle size, removing lumpy calcine, and increases leaching efficiency as a function of the greater surface area of milled calcined mixture.

Conveniently, the calcined mixture is treated to form aluminium chloride, preferably in the form of the aluminium hexahydrate (AICl₃·6H₂O or ACH). This may be achieved by acid leaching the calcined mixture directly with hydrochloric acid or other chloride containing lixiviant solution producing a solid silica enriched by-product and ACH in solution. Silicon levels in the leach solution should be low enough to avoid gel formation. The silica enriched by-product is conveniently separated and sold.

It may be desirable for the calcined mixture, preferably after milling, to be leached with water to remove excess calcium chloride prior to ACH formation. The water leached calcined mixture is directed, following solid-liquid separation, to treatment to form ACH. The calcium chloride containing liquor from the water leach step is preferably directed to a reagent regeneration step. Preferred water leach temperature range is 20 to 95° C. with 20-30° C. being preferred. Preferred water leach duration is 0.5 to 48 hours with 3 hours being more preferred with the ratio of calcined mixture to water ratio preferably being in the range 1:2 to 1:5 with 1:3.5 being more preferred.

Returning to ACH formation, acid leaching of the calcined mixture preferably involves a single or multi-step acid leaching scheme whether involving hydrochloric acid alone or, in the initial stage(s) of a multi-step acid leaching scheme, another acid such as sulphuric acid. An advantageous scheme would involve a single acid leaching, conveniently involving leaching of the calcined mixture with hydrochloric acid.

ACH solution from acid leaching, or other ACH production step, is desirably crystallised to recover ACH. To achieve the required ACH purity, a multi-step crystallisation process-conveniently involving a plurality of ACH crystallisation steps separated by intermediate re-dissolution step(s)—is desirably conducted to provide a purified ACH intermediate or precursor of high purity for high purity alumina production. Two to three ACH crystallisation steps are suitable for the process described here. Hydrochloric acid is conveniently used as a precipitant for ACH crystallisation, saturation of the ACH solution with hydrochloric acid gas causing ACH crystallisation. Redissolution preferably involves deionised water or dilute hydrochloric acid as solvent for ACH crystals.

ACH, preferably in purified and crystallised form as described above, may then be directly calcined at 1000-1600° C., preferably at 1200 to 1300° C., to produce high purity alumina at required specification, for example 99.99% or 4N specification. Preferably, in a prior step, crystallised ACH is roasted at lower temperature, preferably in the range 750-1150° C., to form an amorphous or y-phase alumina before calcination which forms the desired a phase alumina of HPA.

Alternatively to direct calcination which presents a chloride corrosion risk to a calciner though a convenient source of hydrochloric acid for other process steps, the purified crystalline ACH may be dissolved in water, preferably high purity water (for example deionised water, distilled water, ultrapure water (with >18.5Ω being desirable) or a like purified water stream), the product ACH solution being neutralised to form boehmite (AlOOH). Neutralisation of the product ACH solution may involve any convenient alkali; however, an ammonium hydroxide or NH₃/H₂O solution is preferred particularly where an ammonium chloride product of neutralisation is saleable. Ammonium chloride may be separated with boehmite formation potentially taking a longer period. The boehmite is then separated and roasted to form amorphous or y-alumina and then calcined to form high purity alumina (a-alumina phase) at the required specification for commercialization as described above.

The process preferably includes a reagent regeneration step. Conveniently, the chloride containing compound is regenerated for use in step (a), for example by separation from a mixture of chloride salts present in barren liquor from an ACH crystallisation stage. Hydrochloric acid for use in leaching steps, as described above, may also be regenerated.

Prior to the calcination step, the lithium slag may be washed with a suitable acid to remove some of the impurities, such as iron though typically present in relatively low quantity in lithium slag such that discrete purification steps for removal of iron are likely optional or unnecessary. The same is true of impurities such as magnesium, again present in very low quantity in lithium slag as a substantial proportion of impurities are removed in the prior lithium extraction process which results in lithium slag as a by-product. That lithium slag may be processed to recover values, such as high purity alumina (HPA), without specific iron and/or magnesium impurity removal or other treatment steps—for example to purify calcium chloride of magnesium prior to calcining—is a significant advantage of the process described herein.

The lithium slag may also be beneficiated through other mineral processing methods. For example, magnetic particles may be removed through any means of magnetic separation. or the particle sizing may be adjusted and/or lithium slag may be screened to direct a particular or selected particle size fraction to the process.

Producing a high purity alumina specification for commercialization may, if necessary, involve washing and milling steps following production of the high purity alumina.

The process described herein enables a current low-value by-product, lithium slag, to be used for the production of valuable aluminium and silicon containing compounds of high purity in a cost-effective manner where plural reagents can be regenerated and recycled, and waste production minimised.

### BRIEF DESCRIPTION OF THE DRAWINGS

Further features of the process for producing alumina and a lithium salt as described above are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a flow diagram for the process for producing alumina according to a first embodiment of the present invention.

FIG. 2 is a flow diagram for the process for producing alumina according to a second embodiment of the present invention.

### DESCRIPTION OF PREFERRED EMBODIMENTS

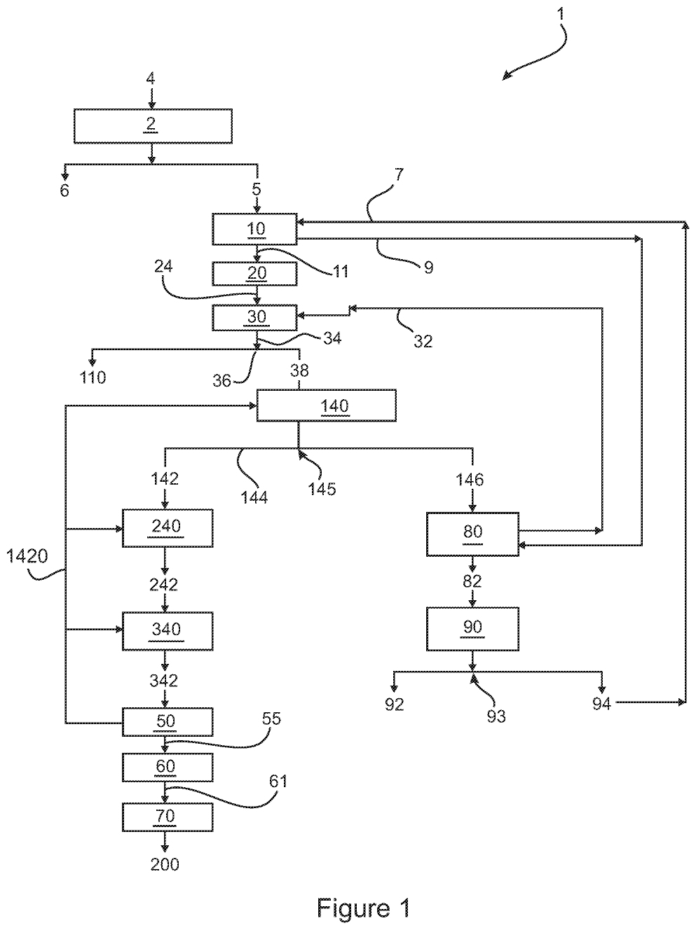

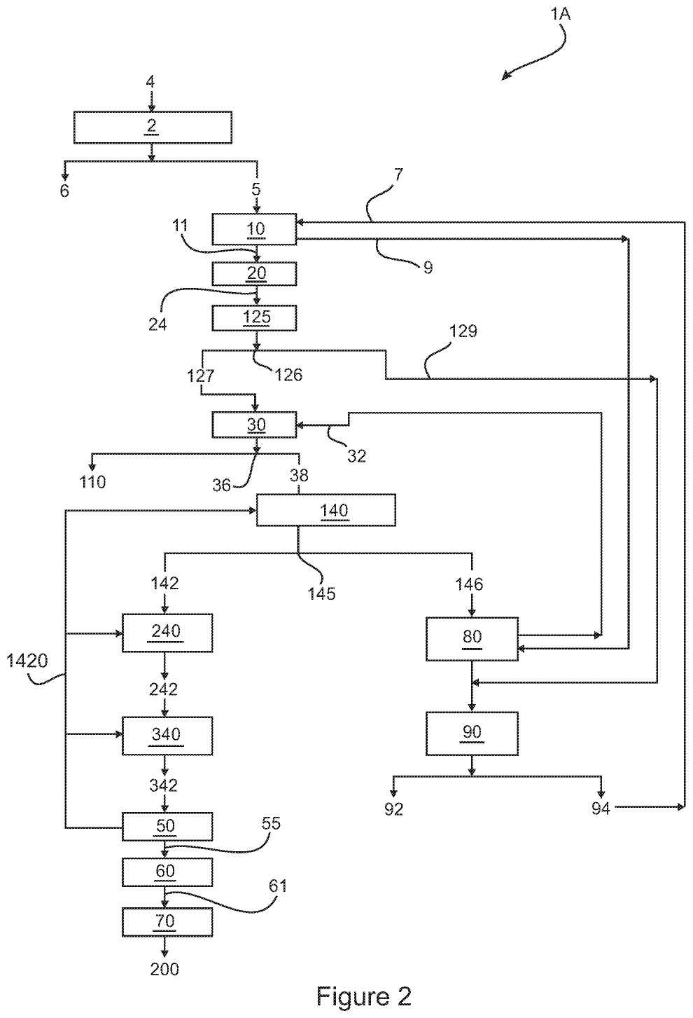

Referring to FIGS. 1 and 2, lithium slag 5 in the form of leached spodumene ore residue for example, is obtained as a waste by-product from lithium refining following a leaching step which liberates substantially all lithium from calcined spodumene (i.e. B-spodumene). The leaching step may involve sulphuric acid or sodium sulphate leaching, for example as described in the Applicant's International Publication No. WO 2021146768, the contents of which are hereby incorporated herein by reference for all purposes. The lithium liberation process also extracts cationic impurities such as iron, magnesium, calcium and others into the leach solution which may be treated by a conventional route to recover lithium hydroxide or lithium carbonate.

The lithium slag 5 (which may contain, for example, Al 12.8 wt %, Si 30.8 wt %, with low levels of iron (0.49 wt %) and very low levels of calcium (0.18 wt %) and magnesium (0.09 wt %)) substantially comprises pyrophyllite (Al₂O₃·4SiO₂·H₂O) which is subjected to process 1 for the recovery of a silica enriched by-product 110 and high purity alumina (HPA) 200.

Lithium slag 4 from a lithium slag stockpile (not shown) is first screened in screening step 2 to produce an undersize lithium slag fraction 5 and an oversize lithium slag fraction 6. The undersize lithium slag fraction 5 contains particles with an average particle size for example less than 53 microns and is directed to calcination step 10, as described below. Oversize lithium slag fraction 6 is returned to the lithium slag stockpile or subjected to size reduction.

Calcining of Lithium Slag with Calcium Chloride or Calcium Chloride Dihydrate

The undersize lithium slag fraction 5 is mixed with a chloride containing compound to form a first solid mixture for treatment in calcination step 10. In this embodiment, solid calcium chloride 7—in anhydrous or crystalline form as calcium chloride dihydrate—is used as chlorine containing compound. Preferably, the crystalline form of calcium chloride dihydrate is used as chlorine containing compound. However, other chloride salts including ferrous or ferric chloride may be used in other embodiments. Ratio of lithium slag residue to chloride compound (by weight) is 1:1 in this example.

Calcination step 10 may be conducted in a rotary kiln or flash calciner of type known in the art of lithium extraction at a temperature of 1000° C. for 1 hour in this example. At this temperature, an acid leachable plagioclase phase may form as detected by XRD analysis.

A calcined mixture 11 from calcination step is rich in calcium aluminosilicate and is easier to leach in hydrochloric acid—as described below—than the aluminosilicate(s) of lithium slag 5.

Calcination step 10, where using calcium chloride dihydrate, releases water and chloride ions to produce hydrochloric acid containing off gas 9 which is directed to hydrochloric acid regeneration step 80.

Leaching efficiency in following acid leaching step 30 is promoted by milling the calcined mixture 11 in milling step 20 to remove any lumpy calcine, increasing surface area for leaching and efficiency. Particle size following milling step 20 is 90% passing 20 microns in this example.

### Production of Aluminium Chloride Hexahydrate as Intermediate in High Purity Alumina Production

In one embodiment, as shown in FIG. 1, the milled calcined mixture 24 is removed from the calcination step 10 and slurried in hydrochloric acid 32 and acid leached in acid leaching step 30, with the object of producing an intermediate to high purity alumina production, aluminium trichloride hexahydrate (AICl₃·6H₂O) or ACH which forms in solution. ACH may be produced in a process involving a single step leach of the milled calcined mixture 24 with hydrochloric acid or in a multi-step process. Advantageously, a single step hydrochloric acid leach is feasible because of the prior calcination step 10 which, in this embodiment through causing formation of a calcium aluminosilicate matrix increases the efficiency of acid leaching step 30.

The hydrochloric acid leach step 30 in this embodiment requires leaching with 25 wt. % hydrochloric acid in slight excess to stoichiometric amounts for reaction to form ACH. That is, just over 3 mole equivalents of HCl for each mole equivalent of aluminium in the residue. Other process conditions in this example are leach temperature 95° C., leach time 3 hours and milled calcined mixture 24: HCl volume ratio of 1:3.5.

The product of acid leaching step 30 is a slurry 34 containing ACH in solution and a silica enriched solid residue as shown in FIGS. 1 and 2. The slurry 34 contains low levels of iron and very low levels of other cationic impurities (e.g. Ca and Mg) such that specific impurity removal step(s) are not required to remove them.

Following solid-liquid separation 36, which may for example involve filtration or centrifugation, the silica enriched solid residue is available as a silica by-product 110. The silica by-product 110 can be sold or further refined.

Following solid-liquid separation 36 of the silica by-product 110 and ACH solution 38, the ACH solution 38 is directed to primary crystallisation stage 140. In primary crystallisation stage 140, ACH is crystallised as primary ACH crystals 142 which are separated from barren liquor 146 by solid-liquid separation step 145, for example involving filtration, to be re-dissolved and re-crystallised in secondary crystallisation stage 240.

Secondary ACH crystals 242 are then re-dissolved and re-crystallised in third crystallisation stage 340 to form pure ACH crystals 342 ready for treatment to produce high purity alumina 55, 200 as described below. Crystallisation of ACH is achieved by saturating the ACH solution in each crystallisation stage 140, 240, 340 with hydrochloric acid gas 1420 through known methods, with the crystallising mixture being kept, in each crystallisation stage, at a temperature range of 40-80° C., to afford the best conditions for precipitation due to the exothermic nature of the crystallisation process. Re-dissolution of ACH crystals 142 and 242 is achieved using deionised water or dilute HCl. Washing of ACH crystals 342 with 36% HCl or ultrapure water (with >18.5Ω being desirable) could be included, if desirable.

### Water Leaching Prior to ACH Formation

In a second embodiment, as shown in FIG. 2, process 1A involves a water leach step 125 prior to ACH production and crystallisation. Water leach step 125 involves leaching of milled calcined mixture 24 in water to remove excess calcium chloride—which could interfere with the crystallisation stages 140, 240, 340—in solution 129. Process conditions in this example are leach temperature 25° C., leach time 3 hours and milled calcined mixture 24: water volume ratio of 1:3.5.

Solution 129 is separated from water leached residue 127 in a solid-liquid separation step 126 and directed to calcium chloride regeneration stage 90. Water leached residue 127 is directed to acid leaching step 30 which proceeds as described above. The process 1A of FIG. 2 is otherwise identical to the process 1 of FIG. 1.

### Production of High Purity Alumina

The purified aluminium chloride hexahydrate (ACH) 342 may then be calcined in calcination step 50 to produce high purity alumina (HPA, a-alumina) 55.

Calcination step 50 also produces a hydrochloric acid gas 1420 which is conveniently directed to crystallisation stages 140, 240 and 340 for saturating ACH solutions and causing ACH crystallisation as described above.

In other embodiments, a roasting step may precede the calcination step 50. Such roasting, preferably in a stationary furnace, causes ACH crystals decompose to amorphous or y-alumina and HCl gas at relatively lower temperature, for example 800° C. in this example. HCl gas would be recycled to the crystallisation stages 140, 240, 340. Chloride is a threat to any calciner due to its corrosion properties, especially at high temperatures of over 1100° C. Calcination of roasted alumina (amorphous or y-alumina) in calcination step 50 would produce HPA which is an a-phase alumina.

As alluded to above, the presence of chloride is a threat to a calciner due to its corrosion properties. To address this, HPA may be produced from purified ACH by an alternative process involving formation of boehmite by neutralisation of ACH crystals, for example with ammonium hydroxide, as described in the Applicant's International Publication No. WO 2021146768, incorporated herein by reference for all purposes. Use of ammonium hydroxide for neutralisation is preferred particularly where an ammonium chloride product of neutralisation is saleable. Ammonium chloride may be separated with boehmite formation potentially taking a longer period. The boehmite is then separated and conveniently roasted to form amorphous or y-alumina and then calcined to form high purity alumina (a-alumina phase) at the required specification for commercialization as described above.

HPA 55 is washed in washing step 60 and milled in milling step 70 to produce HPA 200 of the required specification for commercialization, typically a minimum purity level of 99.99% or 4N. Washing step 60 involves washing with ultrapure water (>18.5Ω), with three washing steps preferably being conducted, to remove any remaining contaminants, such as alkaline metals introduced during the calcination step 50. Washed HPA 61 is filtered and dried and milled in milling step 70 to required size, for example 1 μm. Product HPA 200 is then packaged and sold.

### Regeneration of Reagents

The embodiments above include use of hydrochloric acid produced in calcination step 9 and regeneration of calcium chloride 7 for use in calcination step 10.

Barren liquor 146 from primary crystallisation stage 140 contains hydrochloric acid, calcium chloride and small quantities of calcium, magnesium, iron, sodium and potassium amongst others. Barren liquor 146 (together with a calcium chloride containing solution 129 where a water leach step 125 is employed as described above with reference to FIG. 2) is directed to hydrochloric acid regeneration step 80 where the chlorides are crystallised by saturation with HCl gas 9 as a mixture of calcium, sodium and potassium salts 82 which are removed from HCl 32 which is directed to acid leaching step 30.

In calcium chloride regeneration step 80, calcium chloride 94 is separated in separation step 93 from the other chlorides which are disposed of as stream 92. This process involves re-dissolving the mixed chlorides in water which is directed to a calcium chloride crystalliser in which most of the calcium chloride is recovered as crystalline calcium chloride dihydrate. A bleed stream removes salts such as the sodium and potassium chlorides with a small calcium chloride loss. This loss can be made up with fresh calcium chloride dihydrate. Regenerated calcium chloride 94 is directed as calcium chloride dihydrate 7 to calcination step 10.

The process as described herein has significant potential for increasing profitability of lithium extraction operations by treating a low value leach residue with relatively low levels of impurity elements such as iron and magnesium to produce high purity alumina and silica. At the same time, further commercial benefits can be achieved by recycling reagents to minimise cost and substantially eliminate waste.

Modifications and variations to the process for producing alumina described herein may be apparent to the skilled reader of this disclosure. Such modifications and variations are considered within the scope of the present invention.

Throughout this specification, unless the context requires otherwise, the word “comprise” or variations such as “comprises” or “comprising”, will be understood to imply the inclusion of a stated integer or group of integers but not the exclusion of any other integer or group of integers.

1-31. (canceled)

32. A process for extracting values from a leach residue containing alumina and silica from lithium extraction comprising:
(a) mixing the leach residue with calcium chloride to form a first mixture;
(b) calcining the first mixture to form a calcined mixture rich in calcium aluminosilicate and a hydrochloric acid containing off gas;
(c) acid leaching the calcined mixture with a chloride containing lixiviant to form an aluminium bearing solution containing aluminium chloride hexahydrate (AICl₃·6H₂O or ACH) and a silicon rich solid residue;
(d) recovering values selected from the group consisting of aluminium compounds, silicon compounds and compounds containing silicon and aluminium,
wherein ACH solution from acid leaching step (c) is subjected to crystallisation to recover ACH; and
wherein a barren liquor from ACH crystallisation and containing hydrochloric acid, as well as a mix of chlorides of calcium, magnesium, iron, sodium and potassium is directed to a hydrochloric acid regeneration step where the chlorides are crystallised by saturation and removed from regenerated hydrochloric acid which is directed to acid leaching step (c).

33. A process for extracting values from a leach residue containing alumina and silica from lithium extraction comprising:
(a) mixing a leach residue, formed by sulphuric acid leaching of β-spodumene, with calcium chloride to form a first mixture;
(b) calcining the first mixture to form a calcined mixture rich in calcium aluminosilicate and a hydrochloric acid containing off gas;
(c) water leaching said calcined mixture to recover excess calcium chloride;
(d) acid leaching the calcined mixture with a chloride containing lixiviant to form an aluminium bearing solution containing aluminium chloride hexahydrate (AlCl₃·6H₂O or ACH) and a silicon rich solid residue; and
(e) recovering values selected from the group consisting of aluminium compounds, silicon compounds and compounds containing silicon and aluminium,
wherein ACH solution from acid leaching step (c) is subjected to crystallisation to recover ACH.

34. The process of claim 32, wherein said calcium chloride is in crystalline rather than anhydrous form.

35. The process of claim 34, wherein said chloride compound is calcium chloride dihydrate.

36. The process of claim 32, wherein calcining of the first mixture is conducted at a temperature in the range 800-1100° C.

37. The process of claim 36, wherein calcining duration is 1 to 2.5 hours.

38. The process of claim 36, wherein ratio of leach residue to chloride compound (by weight) is in the range 1:2 to 1:0.33, preferably 1:0.5 to 1:1.

39. The process of claim 33, wherein said calcined mixture is milled prior to acid leaching step (c).

40. The process of claim 33, wherein said treatment is achieved by leaching the calcined mixture directly with hydrochloric acid producing a solid silica enriched by-product and ACH in solution.

41. The process of claim 40, wherein acid leaching of the calcined mixture involves a single or multi-step acid leaching scheme whether involving hydrochloric acid alone or, in a first step of a multi-step acid leaching scheme, another acid, optionally sulphuric acid.

42. The process of claim 33, wherein water leach temperature range is 20 to 95° C.; water leach duration is 0.5 to 48 hours; and the ratio of calcined mixture to water ratio is in the range 1:2 to 1:5.

43. The process of claim 33, wherein calcium chloride containing liquor from the water leach is directed to a reagent regeneration step.

44. The process of claim 32, wherein ACH solution from acid leaching step (c) is crystallised in a plurality of ACH crystallisation steps to recover ACH.

45. The process of claim 44, wherein each of said ACH crystallisation steps is separated by intermediate re-dissolution step(s), re-dissolution preferably involving deionised water or dilute hydrochloric acid as solvent for ACH crystals.

46. The process of claim 44, wherein said barren liquor is directed from a primary stage of crystallisation.

47. The process of claim 33, wherein said crystallised ACH is directly calcined at 1200 to 1300° C., to produce high purity alumina.

48. The process of claim 47, wherein said crystallised ACH is roasted prior to calcination at lower temperature than direct calcination to produce high purity alumina, preferably in the range 750-1150° C., to form an amorphous or y-phase alumina before calcination.

49. The process of claim 47, wherein the crystalline ACH is dissolved in water, preferably high purity water, the product ACH solution being neutralised to form boehmite (AlOOH).

50. The process of claim 49, comprising neutralisation of said product ACH solution with an ammonium hydroxide or NH₃/H₂O solution.

51. The process of claim 50, wherein ammonium chloride formed during said neutralisation is separated followed by boehmite formation.

52. The process of claim 51, wherein said boehmite is then separated and calcined to form high purity alumina (a-alumina phase).

53. The process of claim 52, wherein said boehmite is roasted to form amorphous or y-alumina prior to calcination.

54. The process of claim 32, wherein said mix of chlorides are dissolved in water to form a stream which is directed to a calcium chloride crystalliser in which calcium chloride is regenerated as calcium chloride dihydrate, said regenerated calcium chloride dihydrate being directed to calcination step (b).

55. The process of claim 32, wherein a bleed stream removes salts including sodium and potassium chlorides.
